(19) United States
(12) Patent Application Publication
(10) Pub. No.: US 2010/0083841 A1
(43) Pub. Date: Apr. 8, 2010

(54) BEVERAGE DISPENSING APPARATUS

(75) Inventors: Jean Bergeron, Saint-apollinaire (CA); Marc Saint-Arnaud, Quebec (CA); Alain Normand, Saint-Augustin-de-Desmaures (CA)

Correspondence Address: CANTOR COLBURN, LLP, 20 Church Street, 22nd Floor, Hartford, CT, 06103, US

(73) Assignee: INFUSION INTEGRALE INC., Quebec, Quebec (CA)

(21) Appl. No.: 12/446,688

(22) PCT Filed: Oct. 24, 2007
(86) PCT No.: PCT/CA07/01898

§ 371 Date: Dec. 4, 2009

Related U.S. Application Data
(60) Provisional application No. 60/853,748, filed on Oct. 24, 2006.

(51) Int. Cl. A47J 31/18; A47J 31/41

(52) U.S. Cl. 99/280; 99/295; 99/300; 99/289 R

(57) ABSTRACT

A beverage dispensing apparatus comprises a frame and a liquid injector. The frame includes a receiving station for receiving therein a steeped liquid container including a steeping chamber and a securing mechanism displaceable between an engaged configuration and a disengaged configuration, the securing mechanism being engaged with the steeped liquid container, received in the receiving station, in the engaged configuration and securing the steeped liquid container in a predetermined position therein and disengaged from the steeped liquid container received in the receiving station in the disengaged configuration. The liquid injector is displaceable between an injection position wherein the liquid injector is inserted through the steeped liquid container into the steeping chamber, secured in the predetermined position in the receiving station and a disengaged position wherein the liquid injector is disengaged from the steeped liquid container.

### TECHNICAL FIELD

This invention relates to beverage dispensing and particularly, but not exclusively, to the production and dispensing of brewed liquids such as coffee and tea.

### BACKGROUND OF ART

Over the years, a number of different systems have been proposed for freshly brewing coffee and tea. These generally involve some form of filtration to separate the coffee grounds or tea leaves from the beverage for drinking, and preferably some form of sealed packaging to keep the coffee or tea fresh prior to use.

The idea of sealing fresh coffee or tea in individual packages of an air-impermeable material with a filter material therein is not new. The package is only opened at the time of use, liquid is introduced therein and the extracted liquid removed and transferred into a cup, with the coffee grounds or tea leaves retained by the filter material. The package is then discarded.

Several problems exist with dispensing of coffee or tea from such package, especially where they are intended for dispensing from beverage machines. For example, without being limitative, distinct drinking cup and package are required to provide the beverage. Moreover, it is not possible to control the brewing time of the steeping material.

### DISCLOSURE OF THE INVENTION

It is therefore an aim of the present invention to address the above mentioned issues.

According to an aspect, there is provided a steeped liquid dispensing apparatus comprising: a frame including a receiving station for receiving therein a steeped liquid container including a steeping chamber and a securing mechanism displaceable between an engaged configuration and a disengaged configuration, the securing mechanism being engaged with the steeped liquid container, received in the receiving station, in the engaged configuration and securing the steeped liquid container in a predetermined position therein and disengaged from the steeped liquid container received in the receiving station in the disengaged configuration; and a liquid injector displaceable between an injection position wherein the liquid injector is inserted through the steeped liquid container into the steeping chamber, secured in the predetermined position in the receiving station and a disengaged position wherein the liquid injector is disengaged from the steeped liquid container.

According to another aspect, there is provided a method for providing a steeped liquid comprising: securing a steeped liquid container, inserted in a receiving station of a beverage dispensing apparatus, in a predetermined position by engaging the periphery of the steeped liquid container; inserting a liquid injector in the steeped liquid container through a flow control member thereof; and introducing a liquid in the steeping device through the liquid injector.

According to another aspect, there is provided a beverage dispensing apparatus in combination with a steeping device having repetitions of a machine-readable code. The beverage dispensing apparatus comprises a receiving station for receiving therein the steeping device and a code reader mounted proximate to the receiving station and reading at least one of the machine-readable code repetitions of the steeping device inserted in a non-specific orientation.

According to another aspect, there is provided a beverage dispensing apparatus comprising: a frame including a receiving station for receiving therein a beverage container including a steeping chamber and a peripheral wall; a securing mechanism mounted to the frame and including pivotable securing arms pivoting between an engaged configuration and a disengaged configuration, the securing arms abutting the peripheral wall of the beverage container received in the receiving station and securing the latter in a predetermined position in the engaged configuration and the securing arms being disengaged from the beverage container peripheral wall in the disengaged configuration; and a liquid injector mounted to the frame and displaceable along a substantially vertical axis between an upper injection position wherein the liquid injector is inserted through the beverage container into the steeping chamber, secured in the predetermined position in the receiving station and a lower disengaged position wherein the liquid injector is disengaged from the beverage container.

According to a further aspect, there is provided a steeped liquid dispensing apparatus comprising: a receiving station for receiving therein a steeped liquid container including a steeping chamber and a peripheral wall; means for securing the steeped liquid container in a predetermined position in the receiving station; means for injecting a liquid into the steeped liquid container; means for displacing the securing means from an engaged configuration wherein the steeped liquid container is secured in the predetermined position and a disengaged configuration wherein the steeped liquid container can be inserted into and removed from the receiving station; means for translating the liquid injection means from a disengaged position wherein the liquid injection means are disengaged from the steeped liquid container and an injection position wherein the liquid injection means are inserted through the steeped liquid container and into the steeping chamber.

According to another aspect, there is provided a steeped liquid dispensing apparatus for providing, in a steeped liquid container, a steeped liquid steeped during a predetermined steeping time. The steeped liquid dispensing apparatus comprises: a frame including a receiving station for receiving therein the steeped liquid container and a securing mechanism displaceable between an engaged configuration and a disengaged configuration, the securing mechanism being engaged with the steeped liquid container, received in the receiving station, in the engaged configuration and securing the steeped liquid container in a predetermined position therein and disengaged from the steeped liquid container received in the receiving station in the disengaged configuration; a liquid injector connectable to a liquid supply and displaceable between an injection position wherein the liquid injector is inserted through the steeped liquid container, secured in the predetermined position in the receiving station and a disengaged position wherein the liquid injector is disengaged from the steeped liquid container; and a liquid injection regulating device controlling liquid injection in the liquid injector to obtain the predetermined steeping time.

According to still another aspect, a method for providing a steeped liquid with a predetermined steeping time comprising: securing a steeped liquid container, inserted in a receiving station of a beverage dispensing apparatus, in a predetermined position by engaging the periphery of the steeped liquid container; inserting a liquid injector in the steeped liquid container through a flow control member thereof; and introducing a liquid in the steeped liquid container through the liquid injector with at least one of a predetermined liquid flow rate and a predetermined liquid injection sequence to obtain the predetermined steeping time.

In this specification, the term “steeping” is intended to mean brewing, infusing, mixing, dissolving, soaking, suffuse, and the like wherein a fluid is bring in contact with a liquid or a solid. The term “steeping device” is intended to mean any container, glass, cup, receptacle, can, and the like adapted for steeping two components together.

### BRIEF DESCRIPTION OF DRAWINGS

FIG. 1 is a perspective view of a beverage dispensing apparatus in accordance with an embodiment;

FIG. 2 is a front perspective view of an internal mechanism of the beverage dispensing apparatus shown in FIG. 1;

FIG. 3 is a rear perspective view of the internal mechanism of the beverage dispensing apparatus shown in FIG. 2;

FIG. 4 is a top perspective view of a steeping device securing mechanism and a liquid injector of the beverage dispensing apparatus shown in FIG. 1, in a disengaged configuration;

FIG. 5 is a top plan view of the steeping device securing mechanism and the liquid injector shown in FIG. 4, in the disengaged configuration;

FIG. 6 is an exploded perspective view of an upper plate, a securing arm plate, and a rotating plate mounted to a peripheral wall of the steeping device securing mechanism and the liquid injector shown in FIG. 4;

FIG. 7 is a top perspective view of the steeping device securing mechanism and the liquid injector of the beverage dispensing apparatus shown in FIG. 4, wherein an upper plate is removed;

FIG. 8 is a side elevation view of the steeping device securing mechanism and the liquid injector shown in FIG. 4, in the disengaged configuration;

FIG. 9 is a top plan view of the steeping device securing mechanism and the liquid injector shown in FIG. 4, in an engaged configuration;

FIG. 10 is a bottom plan view of the steeping device securing mechanism and the liquid injector shown in FIG. 4, in the disengaged configuration;

FIG. 11 is a perspective view of the steeping device securing mechanism and the liquid injector shown in FIG. 4, with a steeping device received in a receiving station, in the disengaged configuration;

FIG. 12 is a perspective view of the steeping device securing mechanism and the liquid injector shown in FIG. 10, in the engaged configuration;

FIG. 13 is an enlarged perspective view of the steeping device securing mechanism and the liquid injector shown in FIG. 12;

FIG. 14 is a flow chart illustrating a method for providing a steeped liquid in a steeped liquid container;

FIG. 15 is a flow chart illustrating an alternate method for providing a steeped liquid in a steeped liquid container;

FIG. 16 is a flow chart illustrating a method for securing the steeped liquid container in a predetermined position and injecting a liquid therein;

FIG. 17 is a flow chart illustrating a method for displacing the liquid injector between the engaged and the disengaged positions;

FIG. 18 is a flow chart illustrating a method for reading a machine readable code provided on the steeped liquid container and adjusting liquid injection parameters accordingly; and

FIG. 19 is a flow chart illustrating a method for operating the beverage dispensing apparatus.

It will be noted that throughout the appended drawings, like features are identified by like reference numerals.

### DETAILED DESCRIPTION

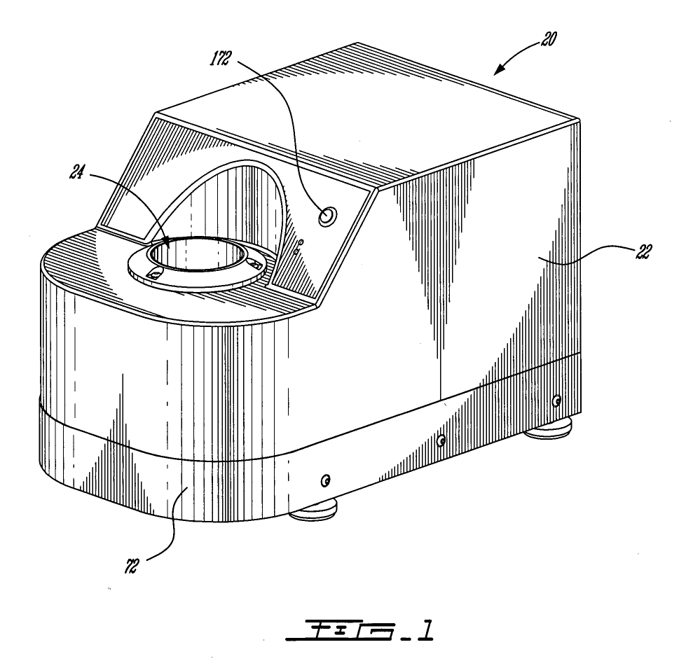

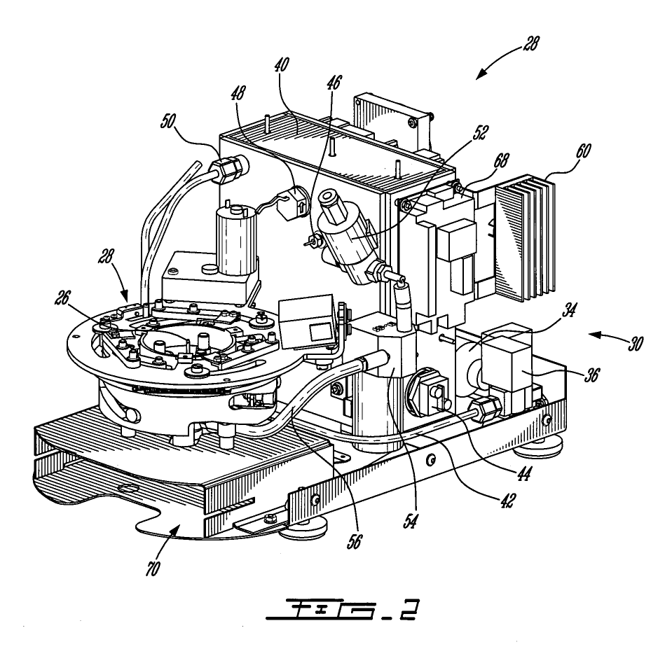

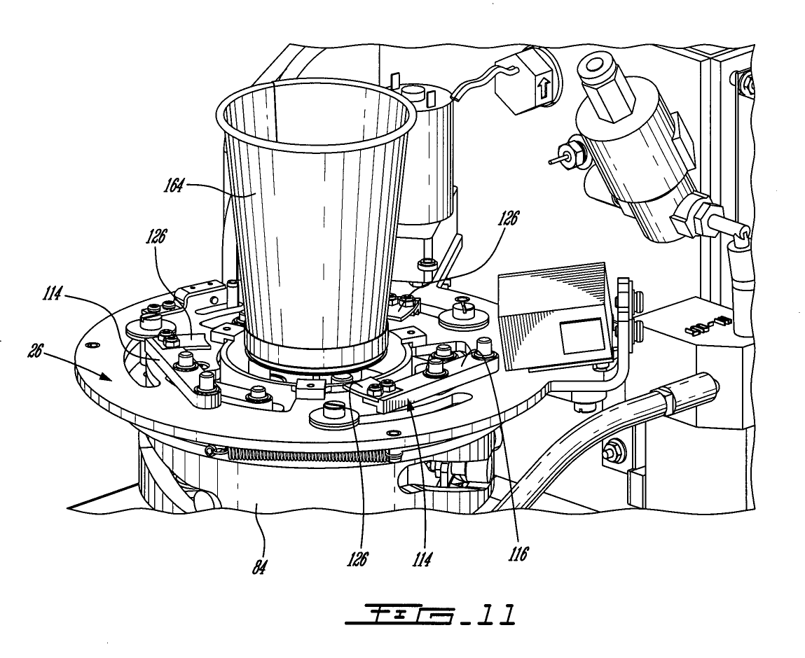

Referring now to the figures, and more particularly referring to FIG. 1, it will be seen a beverage dispensing apparatus 20, or a steeped liquid dispensing apparatus, in accordance with an embodiment. The beverage dispensing apparatus 20 has a housing 22 with a receiving station 24 or a drinking cup insertion socket defined therein. The receiving station 24 has a bottom surface (not shown) with an opening (not shown) defined therein through which a liquid injector 26 (FIG. 2) can translate between a disengaged and an engaged configuration. The receiving station 24 is designed to receive therein a steeped liquid container 164 (or a steeping device) (FIG. 11), similar to the one described in WO 2005/080228 published on Sep. 1, 2005, for instance.

In an embodiment, the steeped liquid container has a steeping chamber in which a liquid or a solid steeping product, such as tea leaves, ground coffee, herbs, spices, neutraceutical products, pharmaceutical products, for instance, can be pre-introduced. The steeping chamber can be in fluid communication with a steeped liquid chamber in which the steeped liquid flows after being introduced in the steeping chamber. It can include a flow control member, such as a one-way flow membrane, which can be pierced, with a sharp instrument such as a needle, for instance, for introducing a liquid in the steeping chamber and, once the sharp instrument is removed, it does not allow leakage of the introduced liquid.

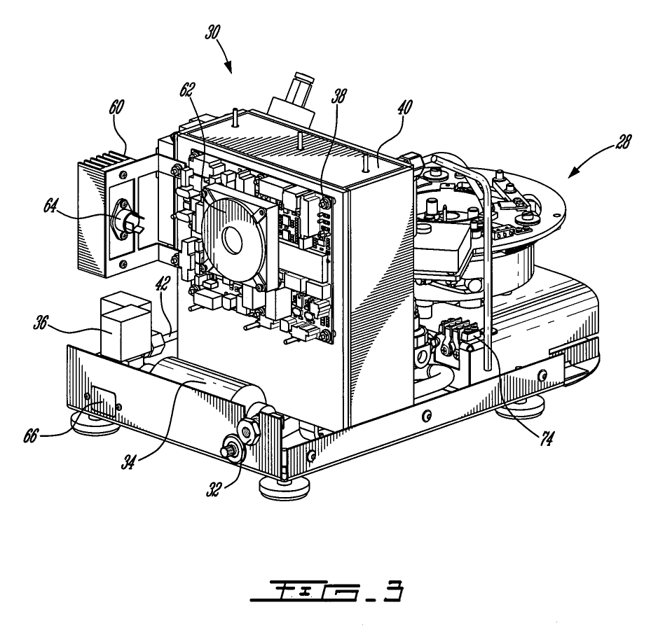

Referring now to FIGS. 2 and 3, it will be seen the internal components of the beverage dispensing apparatus 20 when the housing 22 is removed therefrom. The beverage dispensing apparatus 20 includes a liquid injection and steeping device securing assembly 28, with the liquid injector 26 mounted centrally therein, and a liquid supply assembly 30 in which a liquid flows before being injected in the steeped liquid container through the liquid injector 26.

The liquid supply assembly 30 includes several components which are connected together by liquid conduits in which the liquid flows. The liquid supply assembly 30 includes a liquid connector 32 connectable to a liquid supply (not shown) for feeding the beverage dispensing apparatus 20 with liquid, typically water. The liquid supply can be water ducts, a tank or any other appropriate liquid supply. The liquid flows from the liquid connector 32 into an activated carbon filter 34 to purify the liquid injected in the beverage dispensing apparatus 20.

The liquid then flows into a cold liquid valve 36 which is mounted downstream from the activated carbon filter 34. The cold liquid valve 36 controls the liquid flow in the liquid supply assembly 30. The cold liquid valve 36 is operatively connected to a controller 38 which controls the opening of the cold liquid valve 36. The cold liquid valve 36 is movable between a closed configuration preventing liquid from flowing therethrough and an open configuration allowing liquid to flow therethrough. As it is appreciated, in an alternative embodiment, the cold liquid valve 36 can have a plurality of open configurations allowing various flow rates of liquid to flow therethrough. The liquid flows from the cold liquid valve 36 into a liquid tank 40 through a liquid tank feed conduit 42. The liquid tank 40 includes a liquid heater 44 mounted therein, proximate to the bottom of the tank 40. The liquid heater 44 heats the liquid contained in the tank 40 to inject, if desired, a warm liquid into the steeping device.

A temperature sensor 46 is mounted to the liquid tank 40 to monitor the liquid temperature in the tank 40. The temperature sensor 46 is operatively connected to the controller 38 which, based on data provided by the temperature sensor 46, controls the liquid heater 44. The combination of the temperature sensor 46, the liquid heater 44, and the controller 38 provides a liquid at a set point temperature which corresponds to the user's needs. As it will be described in more details below, the set point temperature can be adjusted in accordance with the steeping material contained in the steeped liquid container.

The liquid tank 40 also includes a liquid level sensor 48 mounted to the tank 40 to monitor the liquid level inside the tank 40. The liquid level sensor 48 is operatively connected to the controller 38 and data monitored by the liquid level sensor 48 are transmitted to the controller 38 which, based on these data, opens or closes the cold liquid valve 36 which is mounted upstream from the tank 40. The liquid level sensor 48, the controller 38, and the cold liquid valve 36 ensure that the tank 40 contains sufficient liquid to respond to user's need for warm liquid supplies.

The liquid tank 40 also includes a tank air vent 50 which allows air contained in the liquid tank 40 to exit therefrom when the tank 40 is being filled with liquid. The tank air vent 50 is mounted in the upper section of the tank housing.

When a liquid supply request is received, liquid contained in the liquid tank 40 flows therefrom into a warm liquid valve 52 mounted downstream therefrom. The warm liquid valve 52 controls the injection of liquid into the liquid injector 26, as will be described in more details below.

The liquid then flows into a pump 54. The pump 54 propels the liquid into the liquid supply assembly 30 from the liquid connector 32 to the liquid injector 26. The pump 54 is operatively connected to the controller 38 and, when the controller 38 receives a signal that a liquid supply is requested, the pump 54 is actuated to propel the liquid therein and the warm liquid valve 52 is opened to allow the liquid to flow into the liquid conduits from the liquid tank 40 into the liquid injector 26. The pump 54 can operate at various speeds thereby controlling the liquid flow rate in the liquid conduits. As it will be described in more details below, the liquid flow rate can be adjusted in accordance with the steeping material contained in the steeped liquid container.

In an embodiment, a piston-type pump is used. The piston-type pump can inject in a single movement all the liquid required for manufacturing a steeped liquid. The pump 54 is connectable to a power supply and the controller 38. It is appreciated that other pump types can be used.

The liquid flows from the pump 54 into the liquid injector 26 through a liquid injector feed conduit 56. The liquid injector 26 has an end port 58 which allows the liquid to flow from the liquid injector 26 into the steeped liquid container/steeping device in which the liquid injector 26 is inserted. The liquid injector 26 can be a needle having a liquid channel defined therein with the end port 58 allowing the liquid to flow outwardly therefrom.

In an alternate embodiment, the liquid injector 26 can have several end ports 58, as it will be described in more details below. The end ports 58 can be located proximate to the injector tip or on a peripheral wall of the injector 26 or any combination thereof.

The controller 38 of the beverage dispensing apparatus 20 is mounted to the liquid tank 40. The controller 38 can be an electronic circuit board which is operatively connected to several components of the beverage dispensing apparatus 20 and in data communication therewith. Amongst others, it controls the cold liquid valve 36, the liquid heater 44, the warm liquid valve 52, the pump 54, and the liquid injection and steeping device securing assembly 28.

It includes a fan 62 for cooling down the controller 38 to prevent overheating. It also includes a liquid temperature control switch 64, such as a TRIAC or bilateral triode switch, which is operatively connected to the liquid heater 44 for controlling the electrical power transmitted thereto. The beverage dispensing apparatus 20 also includes a heat exchanger 60 for cooling down the control switch 64. The power provided to the pump 54, the valves 36, 52, the controller 38, the fan 62, the liquid heater 44 is provided through a power supply connector 66 connectable to a power source (not shown).

The beverage dispensing apparatus 20 also includes a power supply controller 68 which manages the energy between the different components. The power supply controller 68 is connected to the power supply connector 66 and to the various components, as it will be described in more details below.

The liquid injection and steeping device securing assembly 28 is mounted above an insertion cavity 70 in which a liquid recovery drawer 72 (FIG. 1) is inserted. The liquid recovery drawer 72 recovers excess liquid originating from the liquid tank 40, the liquid injector 26, or any other source. The beverage dispensing apparatus 20 also includes a liquid level sensor 74 monitoring the liquid level inside the drawer 72 to prevent overflow.

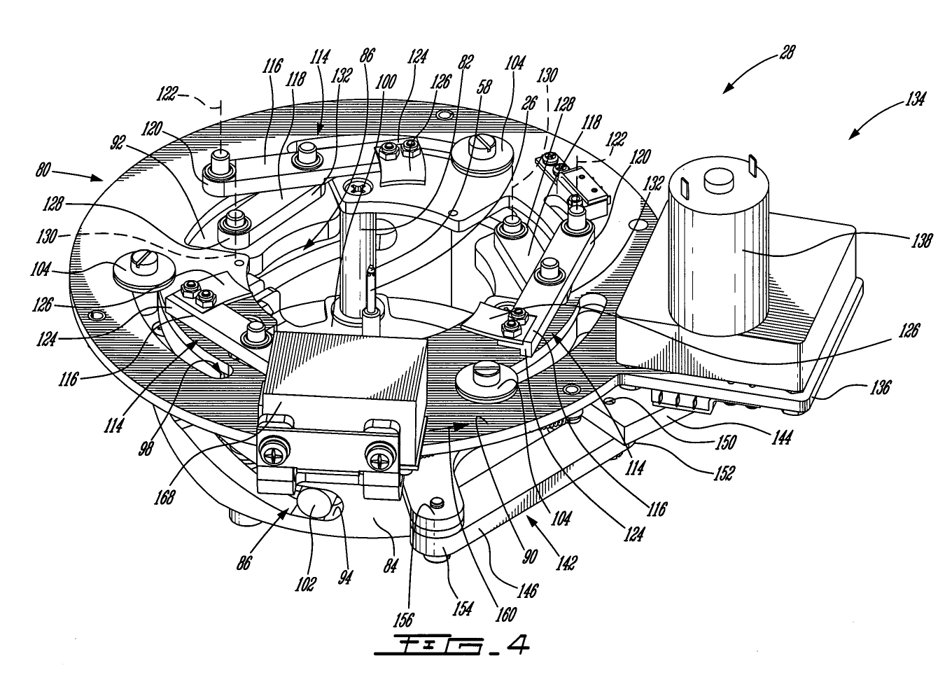

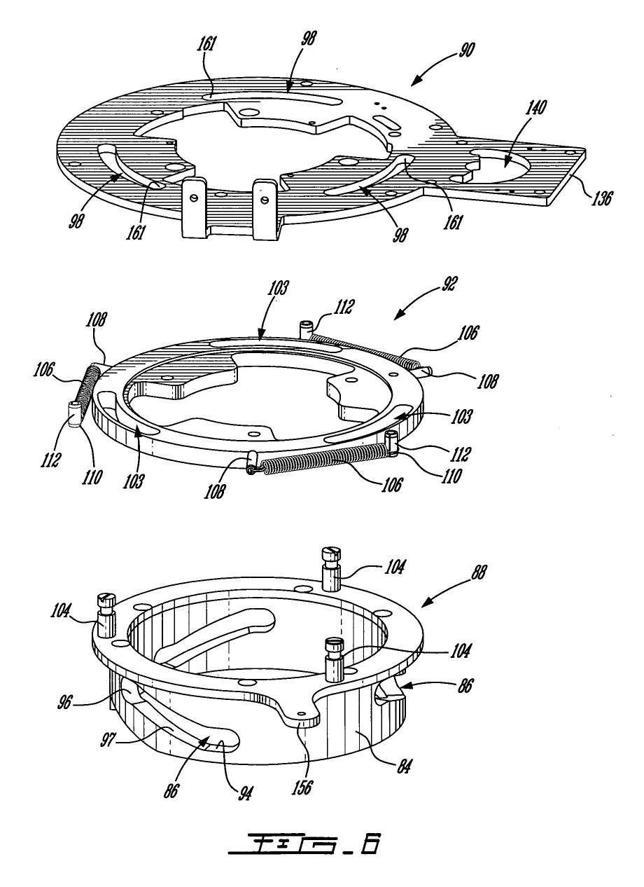

Referring now to FIGS. 4, 5, and 6, the liquid injection and steeping device securing assembly 28, or the cup holder and liquid injector, will be described in more details. A securing mechanism secures a steeped liquid container, or steeping device, in a predetermined position in the receiving station 24. Once the steeped liquid container is secured in the predetermined position, a liquid injection mechanism injects liquid into the steeped liquid container.

More particularly, in an embodiment, the liquid injection and steeping device securing assembly 28 has a frame 80, which is mounted on three vertically extending support members 82, including a peripheral wall 84 with liquid injection guiding grooves 86 defined therein, a rotating plate 88 mounted above the peripheral wall 84, an upper plate 90, and a securing arm plate 92 extending between the rotating plate 88 and the upper plate 90. The securing arm plate 92, the upper plate 90 and the rotating plate 88 have a substantially annular shape. The liquid injection guiding grooves 86 defined in the peripheral wall 84 have a lower section 94, an upper section 96, spaced-apart from the lower section 94, and a diagonally extending section 97 extending between the lower and upper sections 94, 96. The upper plate 90 and the securing arm plate 92 have securing arm guiding grooves 98 and 103 respectively defined therein.

The peripheral wall 84 and the rotating plate 88 are secured together and rotate relatively to the vertically extending support members 82 and a liquid injector plate 100, as will be described in more details below. They rotate between two configurations: an engaged configuration and a disengaged configuration. The rotating plate 88 has securing arm guiding members 104 which extend upwardly and are engaged simultaneously in the securing arm guiding grooves 98 defined in the upper plate 90 and in the guiding grooves 103 defined in the securing arm plate 92.

The securing arm guiding grooves 98 and 103 can be larger than the securing arm guiding members 104 for letting the latter moving freely towards the stepping device.

A liquid injector plate 100 is mounted centrally of the frame 80 and is engaged with the vertically extending support members 82. The liquid injector plate 100 translates vertically relatively to the vertically extending support members 82. It translates between a disengaged configuration and an engaged configuration, as will be described in more details below. The liquid injector 26 is mounted centrally of the liquid injector plate 100. In the engaged configuration of the plate 100, the liquid injector 26 is engaged with the steeping device inserted into the receiving station 24, i.e. it is inserted therein. In the disengaged configuration, the liquid injector 26 is lowered and disengaged from the steeping device.

The liquid injector plate 100 has three liquid injector guiding members 102 mounted at its periphery. The liquid injector guiding members 102 are engaged in the liquid injection guiding grooves 86 defined in the peripheral wall 84 and slide therein between the disengaged and the engaged configurations. In the disengaged configuration, the liquid injector guiding members 102 are located in the lower section 94 of the liquid injection guiding grooves 86 while, in the engaged configuration, the liquid injector guiding members 102 are located in the upper section 96 of the liquid injection guiding grooves 86. When the peripheral wall 84 rotates between the disengaged and engaged configurations, the liquid injector plate 100 simultaneously translates between the disengaged configuration (lower configuration), wherein the liquid injector 26 is disengaged from the steeping device inserted in the receiving station 24, and the engaged configuration (upper configuration), wherein the liquid injector 26 is engaged into the steeping device inserted in the receiving station 24.

The securing arm plate 92 is inserted between the upper plate 90 and the rotating plate 88. The outer diameter of the securing arm plate 92 is smaller than the outer diameter of the upper plate 90. The securing arm guiding members 104 are simultaneously engaged in a respective guiding groove 98 of the upper plate 90 and guiding grooves 103 of the securing arm plate 92.

The securing arm plate 92 rotates between the disengaged and the engaged configurations when the rotating plate 88 is engaged in rotation by an actuator. The degree of rotation of the securing arm plate 92 is narrower than the degree of rotation of the rotating plate 88, as it will be described in more details below. The securing arm plate 92 includes biasing members 106, such as springs, having a first end 108 mounted to the periphery of the securing arm plate 92 and a second end 110 mounted to a downwardly extending member 112 mounted to the upper plate 90. The biasing members 106 rotate the securing arm plate 92 between the disengaged and the engaged configurations when the rotating plate 88 is engaged in rotation by an actuator. In the disengaged configuration, the biasing members 106 are tensed while tension in the biasing members 106 is reduced in the engaged configuration.

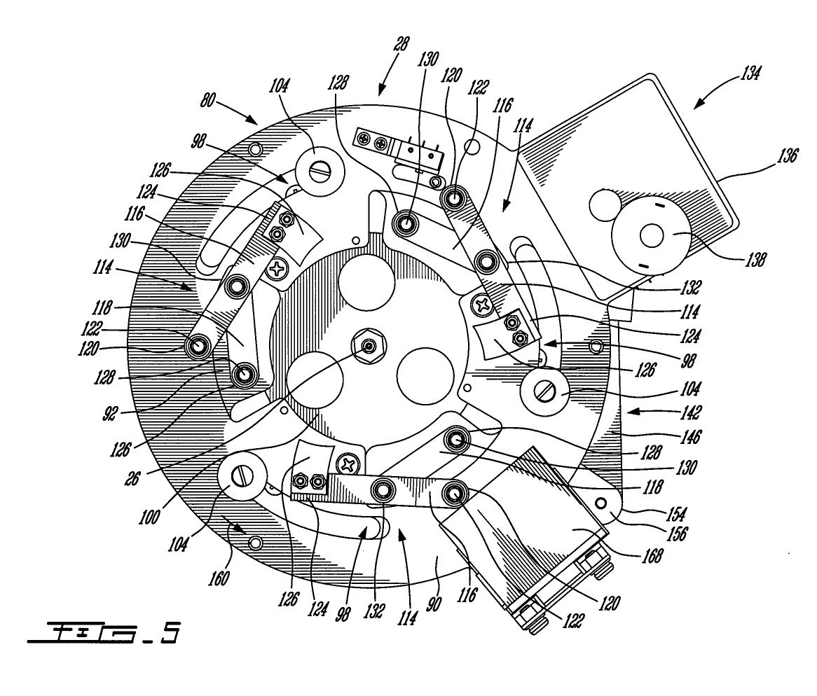

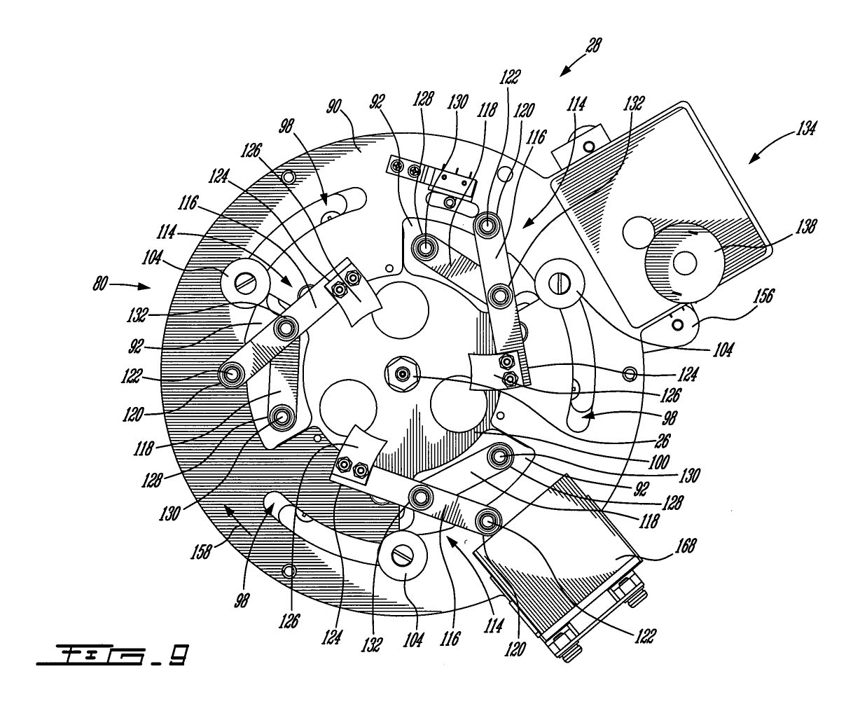

The liquid injection and steeping device securing assembly 28 has three securing arms 114. Each securing arm 114 has a first member 116 and a second member 118 pivotally connected together. The first member 116 has a first end 120 pivotally mounted to the upper plate 90 and pivoting about a first pivot axis 122 and a second end 124 with an abutting member 126 mounted thereto. The abutting member 126 extends inwardly relatively to the liquid injection and steeping device assembly 28. The second member 118 has a first end 128 pivotally mounted to the securing arm plate 92 and pivoting about a second pivot axis 130. The second end 132 of the second member 118 is pivotally mounted to the first member 116, between the first and the second ends 120, 124. Rotation of the securing arm plate 92 between the disengaged and engaged configurations creates a pivoting of the first and second members 116, 118 about the first and second pivot axis 122, 130. The abutting member 126 and the second end 124 thus move between the disengaged configuration (FIG. 5) and the engaged configuration (FIG. 9). In the configuration, the abutting members 126 secure a steeping device inserted in the receiving station 24 in a predetermined position. In the disengaged configuration, the steeping device inserted in the receiving station is released.

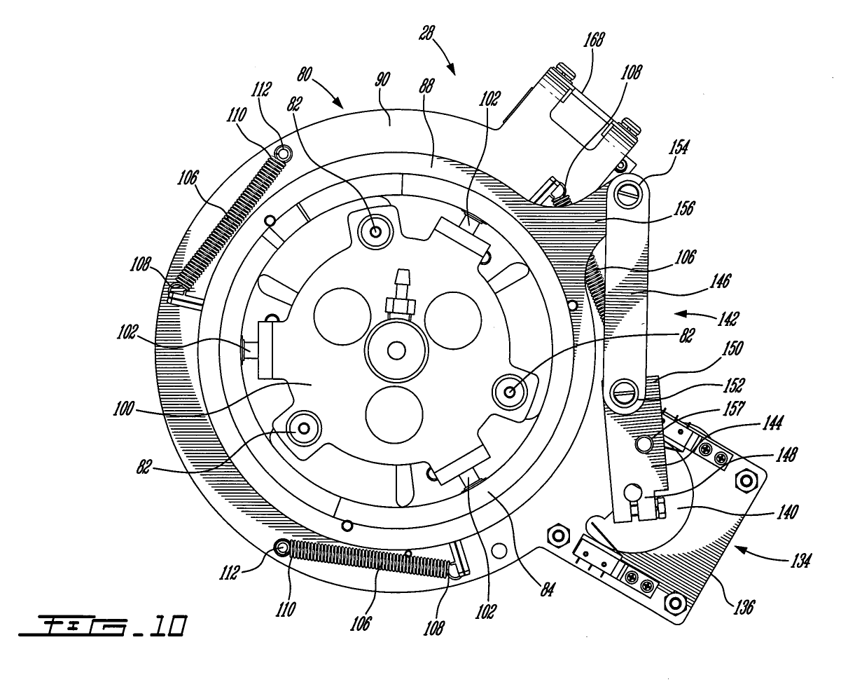

An actuator assembly 134 is mounted to the frame 80 on a gear motor support plate 136, which is an extension of the upper plate 90. The actuator assembly 134 includes a gear motor 138 mounted above the gear motor support plate 136, operatively connected to the power supply controller 68 and the controller 38, and a pivoting arm assembly 142 operatively connected to the gear motor 138. An aperture 140 (FIG. 10) is defined in the gear motor support plate 136. The pivoting arm assembly 142 includes a first and a second pivoting arms 144, 146. The first pivoting arm 144 has a first end 148 pivotally mounted to the gear motor support plate 136 and a second end 150 pivotally mounted to a first end 152 of the second pivoting arm 146. The second pivoting arm 146 has a second end 154 pivotally mounted to an extension member 156 of the rotating plate 88.

The first pivoting arm 142 has an abutting member 157 operatively connected to the gear motor 138 and inserted in the aperture 140 and pivoting therein between a disengaged and an engaged configurations.

The gear motor 138 engages in rotation the pivoting arm 144 between the disengaged and the engaged configurations, the displacement of which is guided by the abutting member 157 inserted in the aperture 140. In the engaged configuration of the pivoting arm assembly 142, the first pivoting arm 144 is superposed to the second pivoting arm 146 (FIG. 9) while, in the disengaged configuration, the first and the second pivoting arms 144, 146 are contiguous to one another (FIG. 4)—except proximate to the second end 150 and the first end 152 where they are superposed.

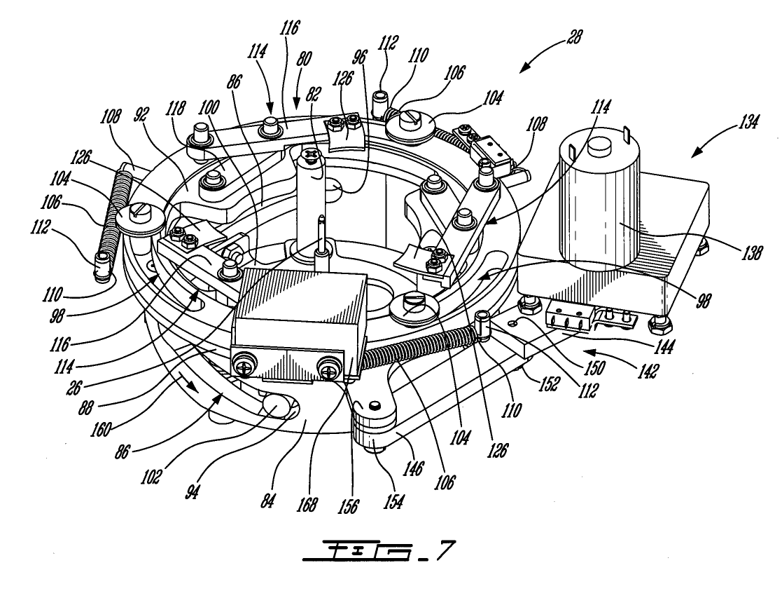

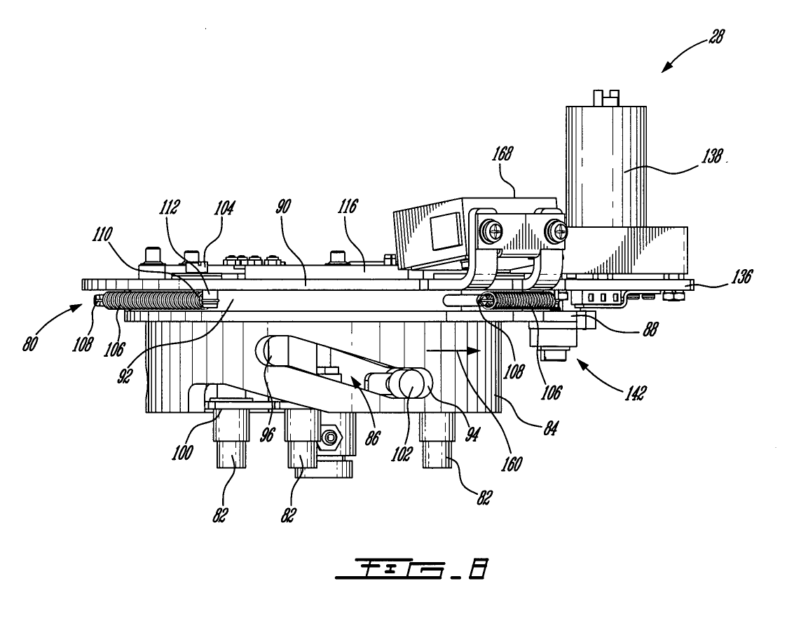

When an instruction is received that a beverage is desired and a steeping device 164 (FIGS. 11-13) is inserted in the receiving station 24, the steeping device 164 is first secured in a predetermined position in the receiving station 24 and then the liquid injector 26 is inserted in the steeping device 164. To secure the steeping device 164 in the predetermined position, the gear motor 138 displaces the abutting member 157 in the aperture 140 into the engaged configuration, from the disengaged configuration. The actuation of the gear motor 138 is controlled by the controller 38 and the power supply controller 68. The pivoting arms 144, 146 are pivoted into the engaged configuration, wherein the pivoting arms 144, 146 are superposed to one another. The second pivoting arm 146 engages in rotation the rotating plate 88 and the peripheral wall 84 by pulling on the extension member 156 of the rotating plate 88 in the direction of arrow 160 (FIGS. 4-8). The rotation of rotating plate 88 and the peripheral wall 84 is guided by the securing arm guiding members 104 inserted in the securing arm guiding grooves 98 of the upper plate 90. The securing arm guiding members 104 translate in the securing arm guiding grooves 98 in the direction of arrow 160.

While rotating between the disengaged and the engaged configurations, the securing arm guiding members 104, mounted to the rotating plate 88, are engaged in the guiding grooves 103 defined in the securing arm plate 92. The tension in the biasing members 106, which were in a tensed—disengaged configuration, is released and the securing arm plate 92 rotates between the disengaged configuration and the engaged configuration. In the disengaged configuration, rotation of the securing arm plate 92 was prevented by the securing arm guiding members 104 abutting an end of the guiding grooves 103. When rotation of the rotating plate 88 occurs, the guiding members 104 are displaced in the rotation direction and simultaneous rotation of the securing arm plate 92 can occur.

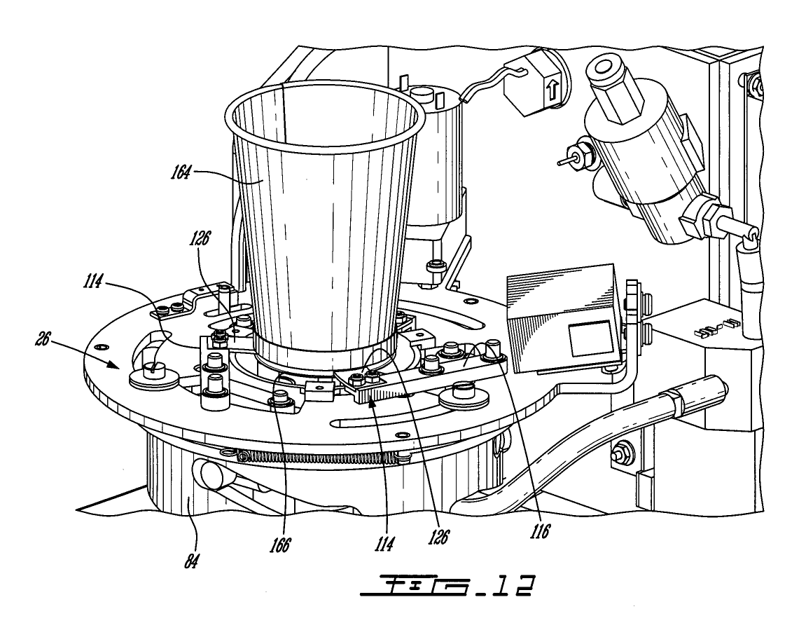

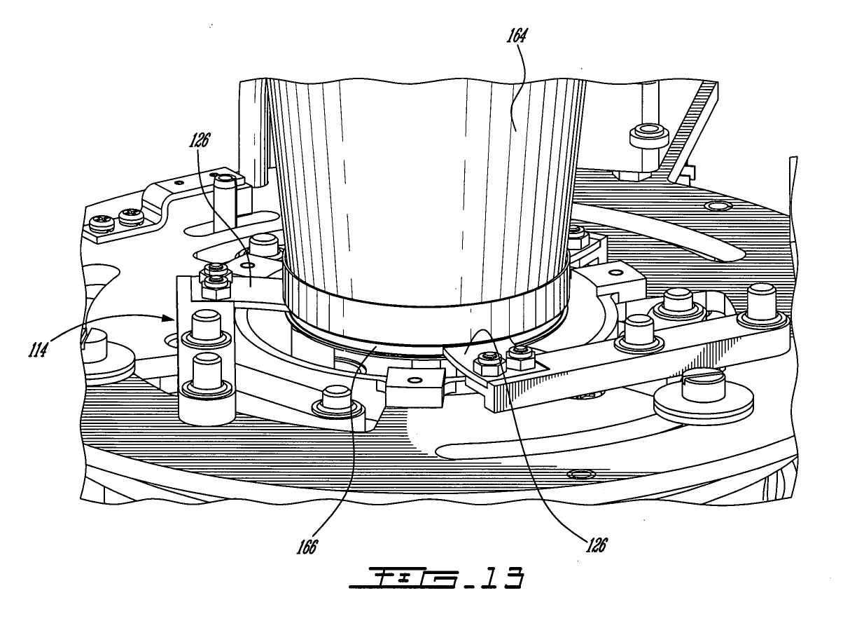

The rotation of the securing arm plate 92 causes the pivoting of the securing arms 114 about the first and the second pivot axis 122, 130 and the simultaneous displacement of the abutting members 126 mounted to the second end 124 of the first securing arm member 116. The abutting members 126, which were in the disengaged configuration, translate inwardly into the engaged configuration and engage the periphery of the steeping device 164 inserted in the receiving station 24, as shown in FIGS. 12 and 13. The abutting members 126, in the engaged configuration, secure the steeping device 164 in the predetermined position. Rotation of the securing arm plate 92 stops when the abutting member 126 engage the periphery of the steeping device.

In FIGS. 12 and 13, the abutting members 126 abut a lower rim 166 of the steeping device 164.

When the rotating plate 88 and the peripheral wall 84 are engaged in rotation between the disengaged and the engaged configurations, the liquid injector guiding members 102, which were located in the lower section 94 of the liquid injection guiding grooves 86 in the disengaged configuration, slide upwardly along the liquid injection guiding grooves 86 into the engaged configuration, i.e. in the upper section 96 of the liquid injection guiding grooves 86. The displacement of the liquid injector guiding members 102 is caused by the rotation of the peripheral wall 84 relatively to the injector plate 100.

Simultaneously, the liquid injector plate 100 translates between the disengaged configuration (lower configuration), wherein the liquid injector 26 is disengaged from the steeping device 164 inserted in the receiving station 24, and the engaged configuration (upper configuration), wherein the liquid injector 26 is engaged into the steeping device 164 inserted in the receiving station 24 and secured in the predetermined position by the abutting members 126. Rotation of the rotating plate 88 and insertion of the liquid injector 26 continue until the guiding members 104 abut a first end 161 of the upper plate guiding grooves 98.

Then, the controller 38 actuates the pump 54 and opens the warm liquid valve 52 and liquid flows from the liquid tank 40 into the steeping device 164 through the conduits and the liquid injector 26 inserted in the steeping device 164.

Once a predetermined liquid quantity has been injected in the steeping device 164, the inverse proceedings are carried out. The controller 38 and the power supply controller 68 actuate the gear motor 138, which rotates in the reverse direction. The gear motor 138 engages in rotation the abutting member 157 of the pivoting arm assembly 142 in the aperture 140, which rotates between the engaged and the disengaged configurations. Simultaneously, the pivoting arm assembly 142 pivots in the disengaged configuration, wherein the pivoting arms 144, 146 are contiguous to one another. The second pivoting arm 146 engages in displacement the rotating plate 88 and the peripheral wall 84 by pushing on the extension member 156 of the rotating plate 88 in the direction of arrow 158 (FIG. 9). The securing arm guiding members 104 translate in the securing arm guiding grooves 98 in the reverse direction of arrow 160 (FIGS. 4-8) to first retract the liquid injector 26 from the steeping device.

While rotating between the engaged and the disengaged configurations, the securing arm guiding members 104, mounted to the rotating plate 88, translate in the guiding grooves 103 defined in the securing arm plate 92. Therefore, the securing arm plate 92 simultaneously rotates between the engaged configuration and the disengaged configuration. The biasing members 106 return in the tensed (or disengaged) configuration.

The rotation of the securing arm plate 92 causes the pivoting of the securing arms 114 about the first and the second pivot axis 122, 130 and the simultaneous displacement of the abutting members 126 mounted to the second end 124 of the first securing arm member 116. The abutting members 126, which were in the engaged configuration, translate outwardly into the disengaged configuration, releasing the steeping device 164 inserted in the receiving station 24, as shown in FIG. 11.

When the rotating plate 88 is engaged in rotation between the engaged and the disengaged configurations, the liquid injector guiding members 102, which were located in the upper section 96 of the liquid injection guiding grooves 86 in the engaged configuration, slide downwardly along the liquid injection guiding grooves 86 into the disengaged configuration, i.e. in the lower section 94 of the liquid injection guiding grooves 86. The displacement of the liquid injector guiding members 102 is caused by the rotation of the peripheral wall 84 relatively to the injector plate 100.

Simultaneously, the liquid injector plate 100 translates between the engaged configuration (upper configuration), wherein the liquid injector 26 is inserted into the steeping device 164, and the disengaged configuration (lower configuration), wherein the liquid injector 26 is disengaged from the steeping device.

The controller 38 and the power supply controller 68 can, at any time, open the cold liquid valve 36 to fill the liquid tank 40.

It is appreciated that steeping devices of various diameters can be inserted in the receiving station. The securing mechanism and, more particularly, the securing members including the securing arms 114, are designed to engage and secure in the predetermined position steeping devices of various sizes. For example, without being limitative, the steeping device can be a 20 oz drinkable liquid container or a 1 oz pharmaceutical liquid container. Accordingly, the securing arms 114 pivots until the engage peripherically the steeping device.

Moreover, the apparatus can include more than one securing mechanism, each securing mechanism being adapted to steeping devices for a certain range of sizes. For example, without being limitative, it can include two securing mechanisms. The first securing mechanism being used for securing steeping devices having a diameter ranging between 3 and 6 cm and the second securing mechanism being used for securing steeping devices having a diameter ranging between 7 and 12 cm, for instance.

It is appreciated that steeping devices of any shape, not only circular shape, can be received in the receiving station. For example, the steeping device can be oval, triangular, square, rectangular, pentagonal, hexagonal, octagonal or other shapes. When the term diameter is used herein, it is defined as the distance from edge to edge when the steeping device is circular. When the steeping device is non-circular, the term diameter is defined as the diameter of a circle which would have the same area as the area of the non-circular steeping device.

The apparatus can include a steeping device abutting sensor which detects when the securing mechanism abuts and secures the steeping device received in the receiving station. It can also include a pressure sensor to prevent overload pressure to be applied to the steeping device. It is appreciated that the steeping device abutting sensor and the pressure sensor can be combined in a single sensor.

The beverage dispensing apparatus 20 can also include a bar code reader 168, mounted to the frame 80, proximate to the receiving station 24. The bar code reader 168 is adapted to read a bar machine-readable code (not shown) printed on or provided on the steeping device and inserted in the receiving station 24. The bar code can include information regarding the content of the steeping device, the liquid quantity requested, the liquid temperature requested, the liquid injection time, the steeping time, etc.

In an embodiment, the bar code is printed several time on the peripheral wall of the steeping device. Therefore, the orientation of the steeping device in the receiving station 24 does not matter since the bar code reader 168 is adapted to read the information provided in the bar code at several locations. The steeping device can thus be inserted in a non-specific orientation and, since the steeping device includes several repetitions of the machine-readable code, the code reader can acquire the information included in the code.

It is appreciated that the bar code, printed on the periphery of the steeping device, can be replaced by any machine-readable representation of information, such as a puce, for instance, and the reader 168 included with the beverage dispensing apparatus 20 is modified accordingly to read the machine-readable code.

In an embodiment, the machine readable code is provided on the peripheral wall of the steeping device. However, in alternate embodiments, the machine readable code can be provided anywhere on the steeping device. For example, without being limitative, it can be provided on the steeping device bottom wall.

The code reader facilitates the apparatus operation. It reduces the consumer operation selection. All information needed for operation is included in the machine readable code. The only consumer choice is the steeping device selection, i.e. tea, coffee, chocolate, etc.

In an embodiment, the code reader is a chip database code reader. The chip is introduced in the stepping device and the signal reading area is located proximate to the steeping device holding area, i.e. the area where the securing mechanism abut the steeping device.

In an embodiment, an instruction is received that a beverage is desired or a beverage dispensing cycle begins when a user pushes on a start button 172 (FIG. 1) located on the front panel of the housing 22. The controller and/or the bar code reader 168 and/or any other steeping device sensor can check if a steeping device is inserted in the receiving station 24 before continuing the beverage dispensing cycle described above. In an alternate embodiment, the beverage dispensing cycle can begin when a steeping device is inserted in the receiving station 24 and is recognized/detected by the apparatus.

The beverage dispensing cycle can be continuous or it can include short downtimes for example to read the information provided on the steeping device.

The apparatus can be adapted to adjust the steeping time in accordance with user's preferences or the properties of the steeping product. By adjusting and controlling the flow rate, amongst other, it is possible to obtain predetermined steeping time in the steeping chamber of the steeped liquid container.

First, the steeping time and/or the liquid injection flow rate can be selected by the user when ordering a steeped liquid. The user can input the desired parameters in a user control panel provided on the apparatus and in data communication with the controller. The user control panel can be a touchscreen or a push button panel. It can include pre-set values or the user can enter any value within a certain range. It is appreciated that the user can also enter other injection or steeping device parameters into the user control panel.

In an alternate embodiment, the steeping time and/or the liquid injection flow rate, as injection parameters, can be provided in the machine-readable code.

The injection parameters, either entered manually by the user or provided with the steeping device, are transmitted to the controller. The controller is operatively connected, such as through wires, to a flow rate regulating device which controls the liquid injection flow rate in the liquid injector. The flow rate regulating device can include a valve regulating the liquid injection flow rate and/or the flow rate regulating device can include a variable speed pump, thereby modifying the pump rotation speed can vary the liquid injection flow rate.

For adjusting and controlling the steeping time, it is also possible to design an injection sequence. For injecting liquid into a steeped liquid container, the pump can be actuated for a time period with a certain injection flow rate. Then the pump and, simultaneously, liquid injection can be stopped for a steeping time period to allow the injected liquid to steep the steeping material. The pump can then be actuated for another time period and stopped again from another steeping time period. The same sequence can be repeated several times until the predetermined liquid volume has been injected, i.e. the liquid dispensing cycle is completed. As for the flow rate control, the injection parameters can be entered manually by the user or provided with the steeping device. The controller is operatively connected to the pump which controls the liquid injection sequence.

It is appreciated that, for adjusting and controlling the steeping time, it is possible to combine both strategies, i.e. the liquid injection flow rate control and the liquid injection sequence. Therefore, the controller can act as a liquid injection regulating device which can combine liquid injection flow rate control and liquid injection sequences to obtain a predetermined steeping time.

As mentioned above, the power supply controller 68 manages, supplied by through the power supply connector 66, the energy between the different components. Amongst other, it is connected to the pump, the various valves, the actuator assembly, the liquid heater, the fan, the code reader, the start button, and the various sensors.

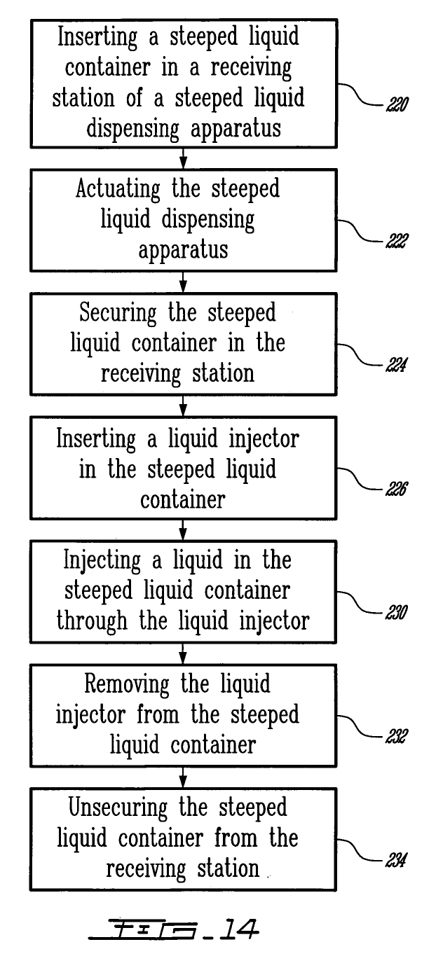

Referring now to FIG. 14, there is shown a method for providing a steeped liquid in a steeped liquid container. First, a steeped liquid container is inserted in the receiving station of the dispensing apparatus 220. The steeped liquid container can be inserted either automatically by the apparatus or manually by a user. Then, the apparatus is actuated for providing a steeped liquid 222. If the steeped liquid container is provided automatically, the apparatus can be actuated before providing the steeped liquid container, for example, by pushing the start button 172.

The steeped liquid container inserted in the receiving station is then secured in a predetermined position 224 and the liquid injector is inserted therein 226. Once inserted, liquid, at a predetermined temperature, is injected into the steeped liquid container 228 and, in an embodiment, into a steeping chamber, through the liquid injector.

Once a predetermined liquid quantity is injected, the liquid injector is removed from the steeped liquid container 230 and the latter is unsecured from the predetermined position 232 and can be removed from the receiving station for completing the liquid dispensing cycle.

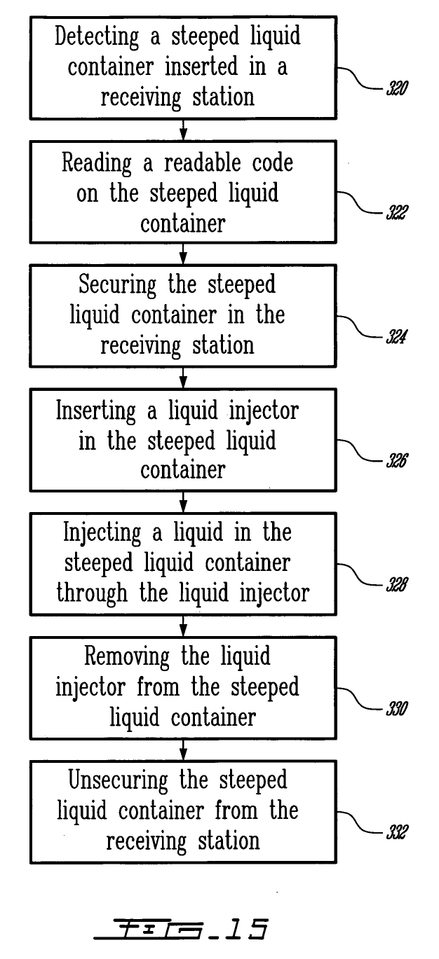

Referring now to FIG. 15, there is shown an alternate method for providing a steeped liquid in a steeped liquid container. The apparatus can include a steeped liquid container sensor for detecting a steeped liquid container inserted into the receiving station 320. Detection of the insertion of steeped liquid container in the receiving station can actuate the apparatus. If a steeped liquid container is detected, a machine readable code can be read on the steeped liquid container 322. If no steeped liquid container is detected, the detection step is repeated until a container is detected.

The machine readable code can include information regarding the product contained in the container and/or the volume of the container, for instance. The information acquired by reading the code can be transferred to a controller, which can be the same than controller 38 in the embodiment described in reference to FIGS. 2-10. The controller can process the information acquire to adjust the liquid injection parameters accordingly. The controller can also adjust promotion parameters.

The liquid injection parameters can be the liquid temperature, the injection flow rate, the liquid volume to be injected, the liquid injection sequence, the steeping time, etc.

Either sequentially or simultaneously with the code reading step 322, the steeped liquid container is secured in the receiving station in a predetermined position 324 and the liquid injector is inserted therein 326. Once inserted, liquid is injected into the steeped liquid container 328. In an embodiment, the liquid is injected in accordance with the liquid injection parameters obtained from the machine readable code or introduced manually by the user in the user control panel.

Once the liquid is injected, the liquid injector 330 is removed from the steeped liquid container and the latter is unsecured from the predetermined position 332 and can be removed from the receiving station.

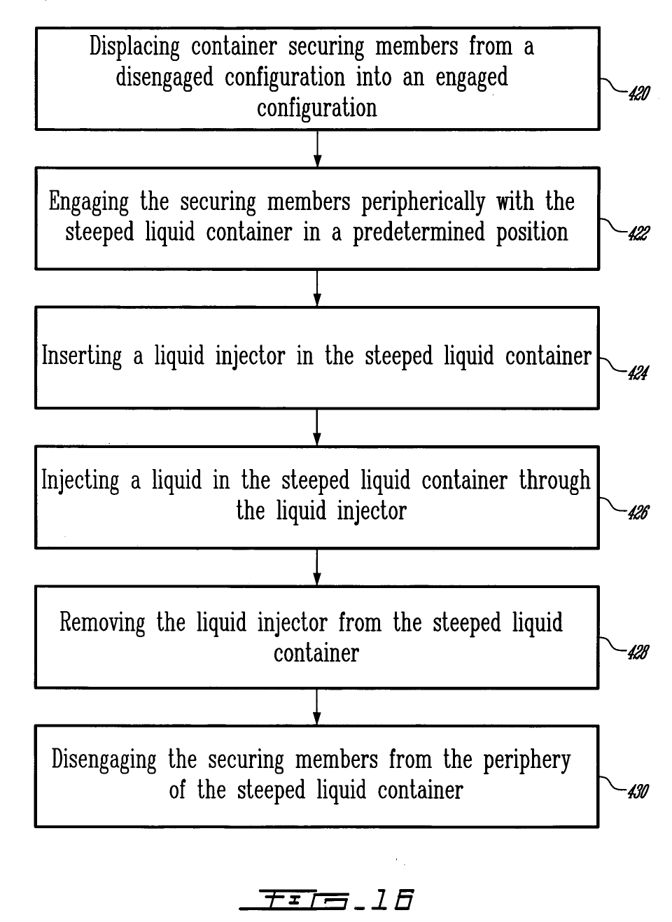

Now, several steps of the methods described above will be described in more details in reference to FIGS. 16-18.

Referring now to FIG. 16, there is shown a method for securing the steeped liquid container in a predetermined position and injecting a liquid therein.

Once the apparatus is actuated, the steeped liquid container is secured in a predetermined position in the receiving station 420 to ensure that the container is not displaced during the insertion of the liquid injector and then liquid injection.

In an embodiment, the apparatus includes container securing members which are configurable in a disengaged configuration, in which steeped liquid containers can be inserted and removed from the receiving station, and an engaged configuration, wherein the inserted steeped liquid container is secured in the predetermined position and the securing members are engaged with the periphery of the container 422.

For securing the steeped liquid container in the predetermined position, the container securing members are displaced from the disengaged configuration, allowing the insertion of the steeped liquid container into the receiving station, into the engaged configuration. In an embodiment, the securing members can pivot about a pivot point to be displaced between both configurations.

As mentioned above, steeped liquid containers of various sizes can be received in the receiving station and secured with the securing mechanism. The securing mechanism can include a pressure sensor to detect that the container is secured and prevent container collapsing if pressure above a pressure threshold is applied to the container.

Once secured in the predetermined position, the liquid injector is inserted in the steeped liquid container 424 and liquid is injected therein 426. When the injection step is completed, the liquid injector is removed from the steeped liquid container 428 and the latter is unsecured from the predetermined position 430 and can be removed from the receiving station.

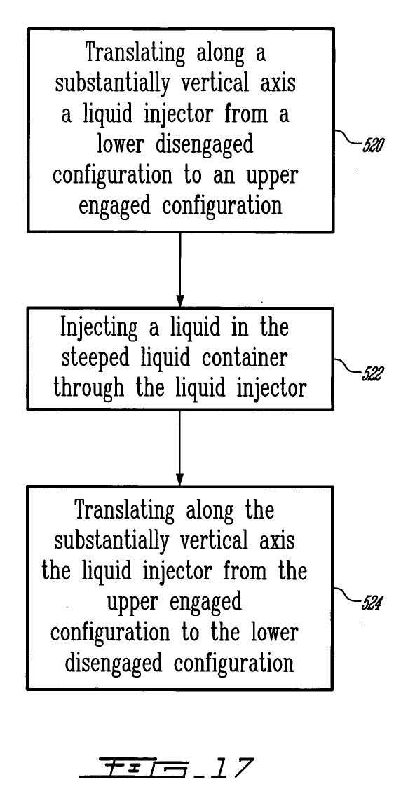

Referring now to FIG. 17, there is shown a method for displacing the liquid injector between the engaged and the disengaged configurations.

Once the steeped liquid container is secured in the predetermined position in the receiving station, the liquid injector is displaced from a disengaged configuration, wherein the liquid injector is not inserted in the liquid container, to an engaged (or injection) configuration, wherein the liquid is inserted in the liquid container. In an embodiment, in the engaged configuration, the liquid injector is inserted in a steeping chamber of the liquid container.

In an embodiment, the liquid injection occurs in the lower section of the liquid container where the steeping material is located. Therefore, the liquid injector translate substantially vertically from a lower disengaged configuration (or position) to an upper engaged configuration (or upper injection position) 520. The liquid injector is inserted through the bottom surface of the steeped liquid container. Then, the liquid is injected in the liquid container 522. When the injection step is completed, the liquid injector is translated along the substantially vertical axis from the upper engaged configuration into the lower disengaged configuration 524.

The liquid injector has a channel longitudinally extending therethrough, in which the liquid flows. It has at least one end port allowing liquid to flow outwardly therefrom.

In an embodiment, the liquid injector 26 has a peripheral wall with a plurality of substantially evenly distributed injection ports. Thereby, when liquid is injected in the steeped liquid container, the pressure applied to the container by the liquid injector is substantially evenly distributed. Moreover, in an embodiment, the injection ports are designed to inject liquid in a substantially horizontal plan.

In an alternate embodiment, the liquid injector can rotate on itself, similar to screwing devices, during the displacement from the disengaged position into the injection position. A liquid injector actuator can induce the rotation movement of the liquid injector during its displacement between both positions. A rotary gasket can be mounted downstream of the liquid injector, either on the input port of the liquid injector and/or the input port of a safety valve.

In another alternate embodiment, the liquid injector has a curved shape. It can be introduced in the steeping device while rotating. In that embodiment, the curved shape liquid injector, such as a curved needle, for instance, is introduced in the stepping device with a rotation movement. The movement of rotation can be induced with a curved cam, such as a curved bar. The curved cam can induce a predetermined penetration angle of the injector in the stepping device. The curved cam is mounted to the apparatus frame and connected therewith at a predetermined rotation point and propelled at its opposite extremity by an actuator.

In some embodiments, a curved liquid injector can allow a relatively easy and sealed penetration in the steeping device. In an embodiment, the rotation diameter of the curved liquid injector ranges between 1 centimeter to 5 meters.

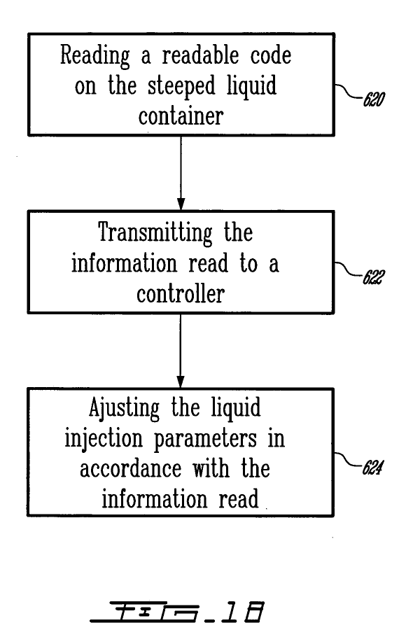

Referring now to FIG. 18, there is shown a method for reading a machine readable code provided on the steeped liquid container and adjusting liquid injection parameters accordingly.

As mentioned above, a machine readable code can be provided on the liquid container. The machine readable code can include information relating to the product contained in the container and/or the volume of the container, and the like.

When the liquid container is inserted in the receiving station, the machine readable code is read by a code reader 620 and the information acquired can be transferred to a controller 622. The controller and the code reader are in data communication for transferring the information acquire during the code reading process. The controller can process the information acquire to adjust the liquid injection parameters accordingly 624. For example, the controller can control the pump, valves, liquid heater, etc.

As mentioned above, the liquid injection parameters can be, for instance, the liquid temperature, the injection flow rate, the liquid volume to be injected, the liquid injection sequence, the steeping time, etc.

In an embodiment, several machine readable codes can be provided on the liquid container. Thereby, the code reader can read the codes for any non-specific orientation of the liquid container in the receiving station.

In an alternate embodiment, the code reader can be displaceable relatively to the apparatus frame. Therefore, once a liquid container is inserted in the receiving station, the code reader can be displaced, by an appropriately designed actuator, until a machine readable code is read.

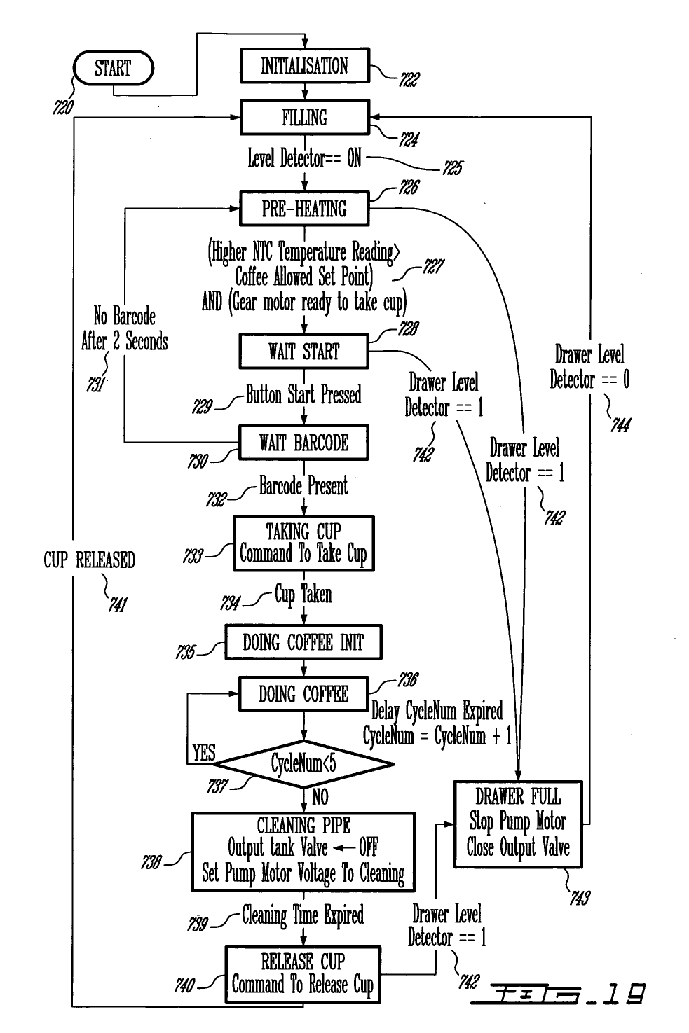

Referring now to FIG. 19, a method for operating the steeped liquid dispensing apparatus is described. First, the apparatus is connected to a power supply and actuated 720. Then initialization of the apparatus occurs 722 and the liquid tank is filled 724. Once a liquid level sensor has detected that the tank is filled 125, the liquid contained in the tank is preheated 726 and, when a thermocouple detects that a temperature set-point is reached 727, the apparatus is ready to begin steeped liquid manufacturing 728. Once the button start is pressed 729, the code reader detects and reads the bar code printed on the steeping device, such as a cup for instance, inserted in the receiving station 730. If the barcode is not read after a predetermined time period 731, such as two seconds, for instance, the apparatus returns to the preheating status 726. If a barcode is detected 732, the information read in the bar code is processed 733 and, when the information is processed 734, the steeping device is secured in the receiving station and the liquid injector is inserted in the steeping device. The steeped liquid manufacturing process, such as coffee for instance, is then carried out 736 during a predetermined number of cycles 737. Once the cycle number is reached, the liquid injector and several liquid conduits are cleaned 738 during a certain time period 739. Then the steeping device is released 740 and can be removed from the receiving station.

Several times during the steeped liquid manufacturing process, the liquid level in the liquid recovery drawer is checked 742 by a liquid level sensor. If the liquid level is higher than a predetermined threshold, the pump motor is stopped and the liquid output valve is closed 743 to prevent steeped liquid manufacturing and overflows. When excess liquid has been removed from the recovery drawer, the apparatus returns to the preheating status 726.

In the embodiment shown in reference to FIGS. 2 to 10, the liquid supply includes a liquid tank 40. A liquid heater 44 is inserted in the liquid tank 40.

In an alternate embodiment (not shown), the beverage dispensing apparatus can be designed without the liquid tank 40. The liquid can be injected directly into the liquid conduits with a liquid heater mounted therein. The beverage dispensing apparatus can be connected to a sufficiently high power supply, such as being characterized by 200 to 230 volts electricity tension, for instance, and install a high power water heater directly on the cold water line to which the liquid injector is in fluid communication. Therefore, the water can be directly heated in the feed conduit to a predetermined temperature. In an embodiment, the heater is mounted in a fluid conduit located after the pump thereby providing an improved control on the flow rate and preventing increased cavitation due to the water temperature. However, in an alternate embodiment, the heater can be mounted in a fluid conduit located downstream to the pump.

In an alternate embodiment, the apparatus can be connected to a natural gas supply or propane supply, which can be portable, as an energy source.

In an alternate embodiment, the liquid can be provided already warm into the beverage dispensing apparatus 20 through a liquid supply connector.

The liquid temperature can be controlled with a controller using a thermocouple mounted proximate to the liquid injector. It can also include a security device with maximum water temperature and power provided to the heater constraints.

The apparatus can include a warm/hot liquid supply and a distinct cold liquid supply, both being in fluid communication with the liquid injector. Therefore, it is possible to design liquid injection sequences which combine sequential warm/hot and cold liquid injections. It is also possible to manufacture cold, warm, or hot steeped liquids. For example, the steeping device can include cold lemonade or iced tea powders or syrups as steeping product. Therefore, cold water is injected through the liquid injector into the steeping device for manufacturing the steeped liquid. In an embodiment, the apparatus can include a by-pass valve allowing either hot/warm liquid or cold liquid to flow in the liquid injector.

It is possible to obtain a variable liquid injection temperature or a variable liquid injection sequence. For example, it is possible to begin the injection process with 100 wt % of hot water during 80 wt % of liquid injection time and finish with 100 wt % of cold water during the remaining 20 wt % of liquid injection time. It is appreciated that a plurality of configuration exists. It is appreciated that the apparatus can provide anything between a cold steeped liquid and a hot steeped liquid.

In an embodiment, the warm liquid valve 52 is a three-way valve having two fluid inputs and a fluid output in fluid communication with the pump 54. A first fluid input is connected to the liquid tank 40 and a second fluid input is in fluid communication with ambient air. Therefore, when the warm liquid valve 52 is closed for liquid communication between the first fluid input and the fluid output, air can flow from warm liquid valve 52 into the liquid injector 26 to clean the liquid conduits. This can occur at the end of each beverage dispensing cycle. In an alternate embodiment, liquid can flow in the conduits and the liquid injector 26 for cleaning purposes at the end of the beverage dispensing cycle.

Furthermore, insertion and removal of the liquid injector, before and after liquid injection, through the flow control member (or membrane) of the steeping device cleans the outer surface of the liquid injector.

In an alternative embodiment, the tank can be pressurized and several valves can be operatively connected to and in fluid communication with the pump, downstream thereof. For example, a first valve can be in fluid communication with the pressurized tank and provide a warm/hot water supply, a second valve can be in fluid communication a cold water supply, and a third valve can permit air aspiration. The third valve allow air injection through the liquid injector to prevent water from stagnating in the liquid injector between steeped steeped liquid manufacturing cycles. Another valve can be mounted to liquid tank to allow air from flowing out thereform and ensure that the tank is constantly full. It is appreciated that other valve configurations can be designed.

In an embodiment, the liquid injection temperature can be proximate to the liquid boiling point. For example, if the steeping product introduced in the steeping device is espresso coffee, water injected in the steeping chamber can be at a temperature proximate to 100° C.

In the embodiment described above in reference to FIGS. 2 to 10, the abutting members 126 have a relatively narrow end which abuts the peripheral wall of the steeped liquid container in the engaged configuration. In an alternate embodiment, the abutting members can include an abutting plate mounted in a substantially perpendicular orientation, the abutting plate being designed to abut the peripheral wall of the steeped liquid container in the engaged configuration and distribute the pressure applied to the container on a larger surface S.

Moreover, in an embodiment, the abutting members, which secure the steeped liquid container in the engaged configuration, are distributed substantially evenly relatively to the peripheral wall of the container to substantially evenly distribute the pressure applied thereto in the engaged configuration and prevent the container from collapsing.

In the embodiment shown in reference to FIGS. 2-10, the apparatus includes a single actuator assembly for actuating the liquid injector and the securing mechanism. However, in an alternate embodiment, it can include a liquid injector actuator and a securing mechanism actuator, totally or partially distinct from the liquid injector actuator. Similarly, they can be controlled independently by different controllers or by the same controller.

In an alternate embodiment, the securing arm covers entirely the size of the brewing chamber by using flexible, pressure resistant, and slip-free hands at least partially surrounding the stepping device received in the receiving station. The hands can be mounted at different heights relatively to one another for securing and preventing any overload pressure during liquid injection.

In the embodiment described in reference to FIGS. 2-10, the securing mechanism applies pressure towards the center of the steeping device in the engaged configuration. However, in an alternate embodiment, the pressure can be applied in an outward direction if the securing mechanism is placed under the steeping device.

In an alternate embodiment, the securing mechanism can include an inflatable membrane mounted at the steeping device circumference. In the inflated configuration, the membrane abuts the steeping device and secures the later in the predetermined position. The membrane can be inflated with a fluid, such as water or air, for instance.

The steeping device holding system and the liquid injection process can be carried out by multiple actuators. These actuators can be of different types such, but not limited to, linear, rotating, and the like. These actuators can be powered by electricity, pneumatic or hydraulic systems.

In an alternate embodiment, the securing mechanism can include two parts, moving face to face in a synchronized manner.

In the embodiment described in reference to FIGS. 2-10, the actuators, such as the pump and the securing mechanism, are operatively connected to a power supply. However, in an alternate embodiment, they can be manually activated.

The embodiments of the invention described above are intended to be exemplary only. For example, it will be appreciated that the shape and the disposition of the various components of the beverage dispensing apparatus 20 can vary. The activated carbon filter can be replaced by any appropriate filter or the beverage dispensing apparatus 20 can be filter-free.

It will be appreciated that the sequence of the components of the liquid supply assembly 30 can vary. For example, the activated carbon filter could be mounted downstream of the cold liquid valve. It will also be appreciated that the liquid injection and steeping device securing assembly 28 can differ from the one described and illustrated above.

A negative ion filter can be mounted internally or externally to the apparatus and be added upstream or downstream to the carbon filter. In an alternate embodiment, the apparatus can be carbon filter free and include an ion filter. It can also include any other appropriate filter and any combination thereof.

The active carbon filter can be mounted internally to the apparatus for more discretion or externally for a relatively easy and rapid maintenance.

The designed of the receiving station and the liquid injector can be adapted to the steeped liquid containers.

Moreover, the dispensing apparatus can be used to provided any steeped liquid and not only beverages. For example, without being limitative, neutraceutics and pharmaceutics products, which need to be diluted in a liquid before being used, can also be disposed within the steeping chambers of the steeping device and diluted with the apparatus. The steeping parameters can be adjusted in accordance with the nature of the steeping material.

For the embodiment described in reference to FIGS. 2-10, an additional check valve can be provided between the entry valve and the liquid supply connection for preventing leaks or liquid return from the beverage dispensing apparatus 20.

An apparatus can include several receiving stations to produce several steeped liquids simultaneously. Therefore, multiple stepping devices can be inserted in a respecting receiving station. The liquid injectors, associated with each receiving station, can be connected to the same liquid tank (or liquid supply) or each can have their own liquid supply, such as several independent almost instantaneous heating systems.

In an embodiment, it is possible to place a safety guard above the stepping device during the liquid injection. The safety guard can prevent contact with the liquid, which can be warm and even hot, during the injection process. A pivotable transparent plate, for instance, can be used as a safety guard. The safety guard can be placed above the stepping device automatically or manually. In an embodiment, liquid injection can be prevented until the safety guard is not disposed above the stepping device. The apparatus can include a position control switch which determines if liquid injection is authorized or not. In an embodiment, a position control switch bypass can also be included.

A security valve can be mounted between the pump and the liquid injector and permit liquid evacuation if the pressure becomes higher than a predetermined threshold during liquid injection.

A screen advertising device providing operation information, publicities or any advertising can be mounted to the beverage dispensing apparatus. It can include a wireless connection for data transmission.

The apparatus can include a coin changer in order to pay per use.

In an alternate embodiment, the steeping device can include a permanent steeped liquid cup (ceramic, metal, plastic cups and the like) with a single use brewing chamber. The brewing chamber can be mounted to the permanent steeped liquid cup in a leak-free manner, such as by clipping for instance. The connection between the brewing chamber and the permanent steeped liquid cup can be carried out automatically by the apparatus or manually by the user. The resulting steeping device can be inserted in the receiving station.

The controller can have a communication port easily accessible allowing to program the configuration and for easy and convenient diagnostic apparatus.

The scope of the invention is therefore intended to be limited solely by the scope of the appended claims.

1. A steeped liquid dispensing apparatus comprising:
a frame including a receiving station for receiving therein a steeped liquid container including a steeping chamber and a securing mechanism displaceable between an engaged configuration and a disengaged configuration, the securing mechanism being engaged with the steeped liquid container, received in the receiving station, in the engaged configuration and securing the steeped liquid container in a predetermined position therein and disengaged from the steeped liquid container received in the receiving station in the disengaged configuration; and
a liquid injector connectable to a liquid supply and displaceable between an injection position wherein the liquid injector is inserted through the steeped liquid container into the steeping chamber, secured in the predetermined position in the receiving station and a disengaged position wherein the liquid injector is disengaged from the steeped liquid container.

2. A steeped liquid dispensing apparatus as claimed in claim 1, wherein the liquid supply comprises a liquid heater.

3. A steeped liquid dispensing apparatus as claimed in claim 1, wherein the liquid supply comprises a liquid tank and a liquid heater mounted in the liquid tank.

4. A steeped liquid dispensing apparatus as claimed in claim 1, comprising a liquid supply connector in fluid communication with the liquid injector and connectable to the liquid supply for supplying liquid to the liquid injector.

5. A steeped liquid dispensing apparatus as claimed in claim 1, wherein the liquid injector is connectable to a cold liquid supply and a warm liquid supply for selective injection of cold liquid and warm liquid.

6. A steeped liquid dispensing apparatus as claimed in claim 1, comprising a liquid injection regulating device controlling liquid injection in the steeped liquid container to obtain a predetermined steeping time, the liquid injection regulating device controlling at least one of liquid injection sequence and liquid injection flow rate.

7. A steeped liquid dispensing apparatus as claimed in claim 1, wherein the securing mechanism comprises a plurality of securing arms pivotally connected to the frame and movable simultaneously between the engaged and the disengaged configurations.

8. A steeped liquid dispensing apparatus as claimed in claim 7, wherein the securing arms provide an evenly distributed pressure to the steeped liquid container secured in the predetermined position.

9. A steeped liquid dispensing apparatus as claimed in claim 1, wherein the liquid injector translates along a vertical axis between the injection position and the disengaged position.

10. A steeped liquid dispensing apparatus as claimed in claim 1, comprising a code reader mounted proximate to the receiving station for reading a machine-readable code provided on the steeped liquid container inserted in the receiving station.

11. A steeped liquid dispensing apparatus as claimed in claim 10, comprising a controller in data communication with the code reader and adjusting the liquid injection parameters in accordance with information provided by the machine-readable code.

12. A steeped liquid dispensing apparatus as claimed in claim 1, wherein the steeped liquid container has a peripheral wall and the securing mechanism is engaged with the peripheral wall of the steeped liquid container in the engaged configuration.

13. A steeped liquid dispensing apparatus as claimed in claim 1, comprising a steeped liquid container sensor mounted to the frame proximate to the receiving station and detecting the insertion of steeped liquid container received in the receiving station.

14. A steeped liquid dispensing apparatus as claimed in claim 1, comprising a single actuator assembly for actuating the liquid injector and the securing mechanism.

15. A steeped liquid dispensing apparatus as claimed in claim 1, wherein the securing mechanism is displaceable into several engaged configurations for securing steeped liquid containers of different sizes, received in the receiving station, in the predetermined position, the engaged configuration corresponding to the size of the steeped liquid container received in the receiving station.

16-23. (canceled)

24. A beverage dispensing apparatus in combination with a steeping device having repetitions of a machine-readable code; the beverage dispensing apparatus comprising a receiving station for receiving therein the steeping device and a code reader mounted proximate to the receiving station and reading at least one of the machine-readable code repetitions of the steeping device inserted in a non-specific orientation.

25. A combination as claimed in claim 24, wherein the beverage container has a peripheral wall and the repetitions of the machine-readable code are provided on the peripheral wall.

26. A combination as claimed in claim 24, comprising a controller in data communication with the code reader and adjusting liquid injection parameters in accordance with information provided by the machine-readable code.

27. A combination as claimed in claim 24, comprising a steeping device sensor provided proximate to the receiving station and detecting the steeping device insertion in the receiving station.

28. A combination as claimed in claim 24, wherein the beverage dispensing apparatus comprises
a securing mechanism displaceable between an engaged configuration and a disengaged configuration, the securing mechanism being engaged with the steeping device, received in the receiving station, in the engaged configuration and securing the steeping device in a predetermined position therein and disengaged from the steeping device received in the receiving station in the disengaged configuration; and
a liquid injector connectable to a liquid supply and displaceable between an injection position wherein the liquid injector is inserted through the steeping device, secured in the predetermined position in the receiving station and a disengaged position wherein the liquid injector is disengaged from the steeping device.

29. A combination as claimed in claim 28, wherein the securing mechanism comprises a plurality of pivotable securing arms movable simultaneously between the engaged and the disengaged configurations.

30. A combination as claimed in claim 28, wherein the liquid injector translates vertically between the injection position and the disengaged position.

31. A beverage dispensing apparatus comprising:
a frame including a receiving station for receiving therein a beverage container including a steeping chamber and a peripheral wall;
a securing mechanism mounted to the frame and including pivotable securing arms pivoting between an engaged configuration and a disengaged configuration, the securing arms abutting the peripheral wall of the beverage container received in the receiving station and securing the latter in a predetermined position in the engaged configuration and the securing arms being disengaged from the beverage container peripheral wall in the disengaged configuration; and
a liquid injector mounted to the frame and displaceable along a substantially vertical axis between an upper injection position wherein the liquid injector is inserted through the beverage container into the steeping chamber, secured in the predetermined position in the receiving station and a lower disengaged position wherein the liquid injector is disengaged from the beverage container.

32. A beverage dispensing apparatus as claimed in claim 31, comprising a liquid supply, with a liquid heater, connectable to the liquid injector for introducing liquid into the steeping chamber through the liquid injector.

33. A beverage dispensing apparatus as claimed in claim 32, wherein the liquid supply comprises a liquid tank and the liquid heater is mounted in the liquid tank.

34. A beverage dispensing apparatus as claimed in claim 31, wherein the securing arms provide an evenly distributed pressure to the beverage container secured in the predetermined position.

35. A beverage dispensing apparatus as claimed in claim 31, wherein the liquid injector has a peripheral wall and a plurality of injection ports distributed evenly on the peripheral wall.

36. A beverage dispensing apparatus as claimed in claim 31, comprising:
a code reader mounted proximate to the receiving station for reading a machine-readable code reproduced on the beverage container inserted in the receiving station; and
a controller in data communication with the code reader and adjusting liquid injection parameters in accordance with information provided by the machine-readable code.

37. A beverage dispensing apparatus as claimed in claim 31, comprising a beverage container sensor provided proximate to the receiving station and detecting the insertion of at least one beverage container received in the receiving station.

38. A beverage dispensing apparatus as claimed in claim 31, comprising a single actuator assembly for actuating the liquid injector and the securing mechanism.

39. A steeped liquid dispensing apparatus comprising:
a receiving station for receiving therein a steeped liquid container including a steeping chamber and a peripheral wall;
means for securing the steeped liquid container in a predetermined position in the receiving station;
means for injecting a liquid into the steeped liquid container;
means for displacing the securing means from an engaged configuration wherein the steeped liquid container is secured in the predetermined position and a disengaged configuration wherein the steeped liquid container can be inserted into and removed from the receiving station;
means for translating the liquid injection means from a disengaged position wherein the liquid injection means are disengaged from the steeped liquid container and an injection position wherein the liquid injection means are inserted through the steeped liquid container and into the steeping chamber.

40. A steeped liquid dispensing apparatus as claimed in claim 39, comprising means for heating the liquid before being injected into the steeped liquid container.

41. A steeped liquid dispensing apparatus as claimed in claim 39, comprising means for connecting a liquid supply to the liquid injector.

42. A steeped liquid dispensing apparatus as claimed in claim 39, comprising means for vertically translating the liquid injector between the injection position and the disengaged position.

43. A steeped liquid dispensing apparatus as claimed in claim 39, comprising a code reader mounted proximate to the receiving station for reading a machine-readable code reproduced on the steeped liquid container inserted in the receiving station.

44. A steeped liquid dispensing apparatus as claimed in claim 39, wherein the securing means are displaceable into several engaged configurations for securing steeped liquid containers of different sizes, received in the receiving station, in the predetermined position, the engaged configuration corresponding to the size of the steeped liquid container received in the receiving station.

45. A steeped liquid dispensing apparatus for providing, in a steeped liquid container, a steeped liquid steeped during a predetermined steeping time, the steeped liquid dispensing apparatus comprising:
a frame including a receiving station for receiving therein the steeped liquid container and a securing mechanism displaceable between an engaged configuration and a disengaged configuration, the securing mechanism being engaged with the steeped liquid container, received in the receiving station, in the engaged configuration and securing the steeped liquid container in a predetermined position therein and disengaged from the steeped liquid container received in the receiving station in the disengaged configuration;
a liquid injector connectable to a liquid supply and displaceable between an injection position wherein the liquid injector is inserted through the steeped liquid container, secured in the predetermined position in the receiving station and a disengaged position wherein the liquid injector is disengaged from the steeped liquid container; and
a liquid injection regulating device controlling liquid injection in the liquid injector to obtain the predetermined steeping time.

46. A steeped liquid dispensing apparatus as claimed in claim 45, wherein the liquid injection regulating device controls at least one of liquid injection flow rate and liquid injection sequence.

47. A steeped liquid dispensing apparatus as claimed in claim 45, wherein the liquid injection regulating device comprises a valve regulating liquid injection flow rate, the valve being operatively connected to a controller.

48. A steeped liquid dispensing apparatus as claimed in claim 45, wherein the liquid injection regulating device comprises a controller providing a liquid injection sequence.

49. A steeped liquid dispensing apparatus as claimed in claim 47, comprising a code reader for reading a machine-readable code provided on the steeped liquid container inserted in the receiving station and containing an indication of the predetermined steeping time, the code reader being operatively connected to the controller.

50-52. (canceled)
